(19) United States
(12) Patent Application Publication
(10) Pub. No.: US 2013/0154996 A1
(43) Pub. Date: Jun. 20, 2013

(54) Touch Sensor Including Mutual Capacitance Electrodes and Self-Capacitance Electrodes

(71) Applicants: Matthew Trend, Fareham (GB); Paul Clements, Whiteley (GB)

(72) Inventors: Matthew Trend, Fareham (GB); Paul Clements, Whiteley (GB)

(21) Appl. No.: 13/328,967

(22) Filed: Dec. 16, 2011

(51) Int. Cl. G06F 3/044

(52) U.S. Cl. 345/174; 178/18.06

(57) ABSTRACT

According to one embodiment, a touch sensor has a first edge and a second edge approximately perpendicular to the first edge. The touch sensor includes a first plurality of electrodes approximately parallel to the first edge, a second plurality of electrodes approximately parallel to the second edge, and a first plurality of nodes. Each of the first plurality of nodes are formed by a capacitive coupling between an electrode of the first plurality of electrodes and an electrode of the second plurality of electrodes. The touch sensor further includes a third plurality of electrodes and a second node formed by the third plurality of electrodes. Each of the third plurality of electrodes form a portion of the second node by a self-capacitance coupling. At least one of the portions of the second node is positioned in-between at least two of the first plurality of nodes.

### BACKGROUND

A touch sensor may detect the presence and location of a touch or the proximity of an object (such as a user's finger or a stylus) within a touch-sensitive area of the touch sensor overlaid on a display screen, for example. In a touch-sensitive display application, the touch sensor may enable a user to interact directly with what is displayed on the screen, rather than indirectly with a mouse or touchpad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch sensors, such as (for example) resistive touch screens, surface acoustic wave touch screens, and capacitive touch screens. Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A touch-sensor controller may process the change in capacitance to determine its position on the touch screen.

Touch sensors typically include an electrode pattern, such as one of the electrode patterns included in the touch sensors illustrated in FIGS. 1E-1G. Touch sensors with these typical electrode patterns, however, may be deficient.

### BRIEF DESCRIPTION OF THE DRAWINGS

FIG. 1A illustrates an example touch sensor with an example touch-sensor controller.

FIG. 1B illustrates a system with a single-layer configuration of electrodes that implement self-capacitive coupling.

FIG. 1C illustrates a system with a single-layer configuration of electrodes that implement mutual capacitance coupling.

FIG. 1D illustrates a system with a two-layer configuration of electrodes that implement mutual capacitance coupling.

FIG. 1E illustrates an example touch sensor having a two-layer configuration of electrodes that implement mutual capacitance coupling.

FIG. 1F illustrates another example touch sensor having a two-layer configuration of electrodes that implement mutual capacitance coupling.

FIG. 1G illustrates another example touch sensor having a two-layer configuration of electrodes that implement mutual capacitance coupling.

FIG. 2A-2B illustrate example touch sensors that include both electrodes that implement mutual capacitance coupling and electrodes that implement self-capacitance coupling.

FIG. 3 illustrates another example touch sensor that includes both electrodes that implement mutual capacitance coupling and electrodes that implement self-capacitance coupling.

FIG. 4 illustrates another example touch sensor that includes both electrodes that implement mutual capacitance coupling and electrodes that implement self-capacitance coupling.

FIG. 5 illustrates a device that may incorporate any of the touch sensors of FIGS. 1A-4.

### DESCRIPTION OF EXAMPLE EMBODIMENTS

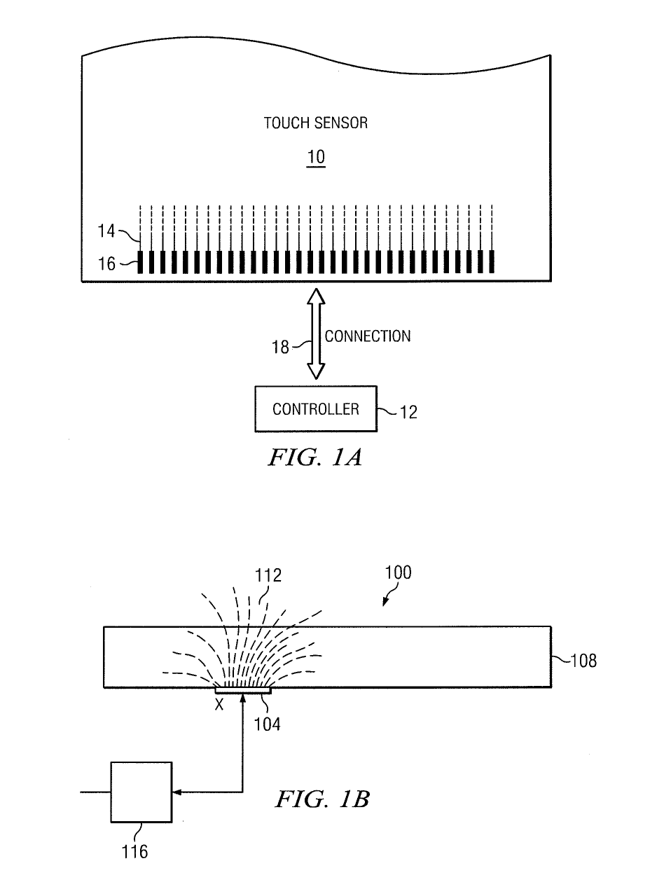

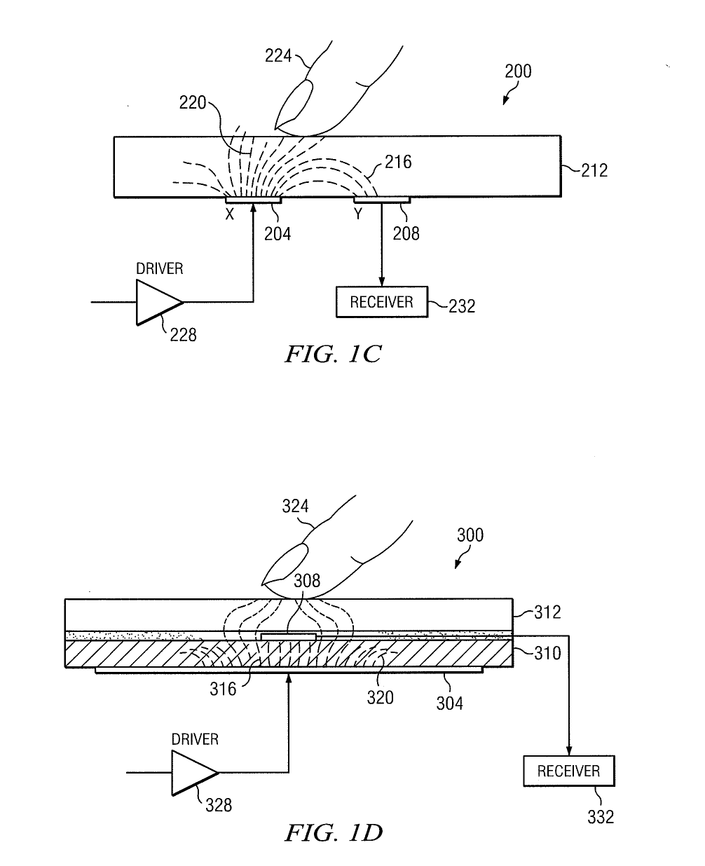

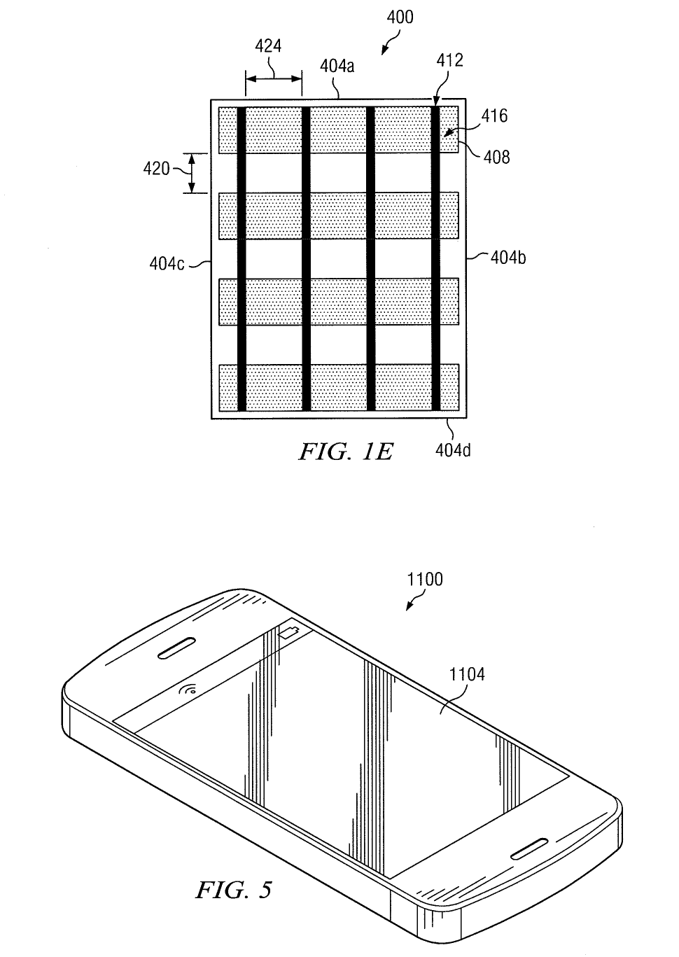

FIG. 1A illustrates an example touch sensor 10 with an example touch-sensor controller 12. Touch sensor 10 and touch-sensor controller 12 may detect the presence and location of a touch or the proximity of an object within a touch-sensitive area of touch sensor 10. Herein, reference to a touch sensor may encompass both the touch sensor and its touch-sensor controller, where appropriate. Similarly, reference to a touch-sensor controller may encompass both the touch-sensor controller and its touch sensor, where appropriate. Touch sensor 10 may include one or more touch-sensitive areas, where appropriate. Touch sensor 10 may include an array of drive and sense electrodes (or an array of electrodes of a single type) disposed on one or more substrates, which may be made of a dielectric material. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode (whether a drive electrode or a sense electrode) may be an area of conductive material forming a shape, such as for example a disc, square, rectangle, thin line, other suitable shape, or suitable combination of these. One or more cuts in one or more layers of conductive material may (at least in part) create the shape of an electrode, and the area of the shape may (at least in part) be bounded by those cuts. In particular embodiments, the conductive material of an electrode may occupy approximately 100% of the area of its shape. As an example and not by way of limitation, an electrode may be made of indium tin oxide (ITO) and the ITO of the electrode may occupy approximately 100% of the area of its shape (sometimes referred to as 100% fill), where appropriate. In particular embodiments, the conductive material of an electrode may occupy substantially less than 100% of the area of its shape. As an example and not by way of limitation, an electrode may be made of fine lines of metal or other conductive material (FLM), such as for example copper, silver, or a copper- or silver-based material, and the fine lines of conductive material may occupy approximately 5% of the area of its shape in a hatched, mesh, or other suitable pattern. Herein, reference to FLM encompasses such material, where appropriate. Although this disclosure describes or illustrates particular electrodes made of particular conductive material forming particular shapes with particular fills having particular patterns, this disclosure contemplates any suitable electrodes made of any suitable conductive material forming any suitable shapes with any suitable fill percentages having any suitable patterns.

Where appropriate, the shapes of the electrodes (or other elements) of a touch sensor may constitute in whole or in part one or more macro-features of the touch sensor. One or more characteristics of the implementation of those shapes (such as, for example, the conductive materials, fills, or patterns within the shapes) may constitute in whole or in part one or more micro-features of the touch sensor. One or more macro-features of a touch sensor may determine one or more characteristics of its functionality, and one or more micro features of the touch sensor may determine one or more optical features of the touch sensor, such as transmittance, refraction, or reflection.

A mechanical stack may contain the substrate (or multiple substrates) and the conductive material forming the drive or sense electrodes of touch sensor 10. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. The mechanical stack may also include a second layer of OCA and a dielectric layer (which may be made of PET or another suitable material, similar to the substrate with the conductive material forming the drive or sense electrodes). As an alternative, where appropriate, a thin coating of a dielectric material may be applied instead of the second layer of OCA and the dielectric layer. The second layer of OCA may be disposed between the substrate with the conductive material making up the drive or sense electrodes and the dielectric layer, and the dielectric layer may be disposed between the second layer of OCA and an air gap to a display of a device including touch sensor 10 and touch-sensor controller 12. As an example only and not by way of limitation, the cover panel may have a thickness of approximately 1 mm; the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

One or more portions of the substrate of touch sensor 10 may be made of polyethylene terephthalate (PET), silver on PET, carbon on PET, printed circuit board (PCB), flexible circuit board (FCB), glass, or another suitable material. This disclosure contemplates any suitable substrate with any suitable portions made of any suitable material. In particular embodiments, the drive or sense electrodes in touch sensor 10 may be made of ITO in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness of approximately 5 μm or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a space between them. A pulsed or alternating voltage applied to the drive electrode (by touch-sensor controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and touch-sensor controller 12 may measure the change in capacitance. By measuring changes in capacitance throughout the array, touch-sensor controller 12 may determine the position of the touch or proximity within the touch-sensitive area(s) of touch sensor 10.

In a self-capacitance implementation, touch sensor 10 may include an array of electrodes of a single type that may each form a capacitive node. When an object touches or comes within proximity of the capacitive node, a change in self-capacitance may occur at the capacitive node and touch-sensor controller 12 may measure the change in capacitance, for example, as a change in the amount of charge needed to raise the voltage at the capacitive node by a pre-determined amount. As with a mutual-capacitance implementation, by measuring changes in capacitance throughout the array, touch-sensor controller 12 may determine the position of the touch or proximity within the touch-sensitive area(s) of touch sensor 10. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have drive and sense electrodes disposed in a pattern on one side of a single substrate. In such a configuration, a pair of drive and sense electrodes capacitively coupled to each other across a space between them may form a capacitive node. For a self-capacitance implementation, electrodes of only a single type may be disposed in a pattern on a single substrate. In addition or as an alternative to having drive and sense electrodes disposed in a pattern on one side of a single substrate, touch sensor 10 may have drive electrodes disposed in a pattern on one side of a substrate and sense electrodes disposed in a pattern on another side of the substrate. Moreover, touch sensor 10 may have drive electrodes disposed in a pattern on one side of one substrate and sense electrodes disposed in a pattern on one side of another substrate. In such configurations, an intersection of a drive electrode and a sense electrode may form a capacitive node. Such an intersection may be a location where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Touch-sensor controller 12 may detect and process the change in capacitance to determine the presence and location of the touch or proximity input. Touch-sensor controller 12 may then communicate information about the touch or proximity input to one or more other components (such one or more central processing units (CPUs)) of a device that includes touch sensor 10 and touch-sensor controller 12, which may respond to the touch or proximity input by initiating a function of the device (or an application running on the device). Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 12 may be one or more integrated circuits (ICs), such as for example general-purpose microprocessors, microcontrollers, programmable logic devices or arrays, application-specific ICs (ASICs). In particular embodiments, touch-sensor controller 12 comprises analog circuitry, digital logic, and digital non-volatile memory. In particular embodiments, touch-sensor controller 12 is disposed on a FPC bonded to the substrate of touch sensor 10, as described below. The FPC may be active or passive, where appropriate. In particular embodiments, multiple touch-sensor controllers 12 are disposed on the FPC. Touch-sensor controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular touch-sensor controller having a particular implementation with particular components, this disclosure contemplates any suitable touch-sensor controller having any suitable implementation with any suitable components.

Tracks 14 of conductive material disposed on the substrate of touch sensor 10 may couple the drive or sense electrodes of touch sensor 10 to connection pads 16, also disposed on the substrate of touch sensor 10. Tracks 14 and connection pads 16 may be disposed on the same side of the substrate as the drive or sense electrodes, on a different side of the substrate than the drive or sense electrodes (e.g., vias in the substrate may allow the tracks 14 to couple the drive or sense electrodes to connection pads 16), or on a different layer than the drive or sense electrodes. As described below, connection pads 16 facilitate coupling of tracks 14 to touch-sensor controller 12. Tracks 14 may extend into or around (e.g. at the edges of) the touch-sensitive area(s) of touch sensor 10. Particular tracks 14 may provide drive connections for coupling touch-sensor controller 12 to drive electrodes of touch sensor 10, through which the drive unit of touch-sensor controller 12 may supply drive signals to the drive electrodes. Other tracks 14 may provide sense connections for coupling touch-sensor controller 12 to sense electrodes of touch sensor 10, through which the sense unit of touch-sensor controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (which may be a connection pad 16) at an edge of the substrate of touch sensor 10 (similar to tracks 14).

Connection pads 16 may be located along one or more edges of the substrate, outside the touch-sensitive area(s) of touch sensor 10. As described above, touch-sensor controller 12 may be on an FPC. Connection pads 16 may be made of the same material as tracks 14 and may be bonded to the FPC using an anisotropic conductive film (ACF). Connection 18 may include conductive lines on the FPC coupling touch-sensor controller 12 to connection pads 16, in turn coupling touch-sensor controller 12 to tracks 14 and to the drive or sense electrodes of touch sensor 10. In another embodiment, connection pads 16 may be connected to an electro-mechanical connector (such as a zero insertion force wire-to-board connector); in this embodiment, connection 18 may not need to include an FPC. This disclosure contemplates any suitable connection 18 between touch-sensor controller 12 and touch sensor 10.

FIG. 1B illustrates a system 100 with a single-layer configuration of electrodes that implement self-capacitance coupling. In particular embodiments, the electrode configuration of system 100 of FIG. 1B may be an example of an electrode configuration of touch sensor 10 of FIG. 1A.

According to the illustrated embodiment, field lines 112 extend from an electrode 104 (e.g. a drive electrode) operated by a circuit 116, the fields penetrating through panel 108. A portion of the emitted field lines 112 escapes into free space or other parts of the panel as shown and capacitively couples with a finger (not shown) or other object when present. The circuit 116 observes a change in self-capacitance of the capacitive node formed by electrode 104 due to the presence of a finger (or other object) near field lines 112, such as by observing that a greater charge is needed to change the voltage of the capacitive node.

In particular embodiments, because electrodes that implement self-capacitance coupling may cause the emitted field lines 112 to escape into free-space (e.g., beyond the panel 108), electrodes that implement self-capacitance coupling may be good at detecting when an object (such as a finger) is near the panel, but not touching the panel. That is, electrodes that implement self-capacitance coupling may be good at detecting proximity. On the other hand, electrodes that implement self-capacitance coupling may not be good at detecting when an object touches the panel. As such, in particular embodiments, electrodes that implement self-capacitance coupling may primarily be used in a touch screen to detect when an object is near the panel, but not touching the panel (e.g., detecting proximity).

FIG. 1C illustrates a system 200 with a single-layer configuration of electrodes that implement mutual capacitance coupling. In particular embodiments, the electrode configuration of system 200 of FIG. 1C may be an example of an electrode configuration of touch sensor 10 of FIG. 1A.

According to the illustrated embodiment, a finger 224 causes field lines 216 normally coupling from drive electrode 204 to sense electrode 208 to be absorbed by finger 224, as shown at 220. The result of this action is a very detectable change in capacitance of the capacitive node formed by drive electrode 204 and sense electrode 208. In particular embodiments, the change in capacitance is related to a variety of factors such as fingerprint area, electrode area, panel 212 thickness and dielectric constant, human body size and location, skin thickness and conductivity, and other factors. In particular embodiments, the change in capacitance is sensed by receiver 232.

In particular embodiments, contrary to electrodes that implement self-capacitance coupling (discussed above in conjunction with FIG. 1B), electrodes that implement mutual capacitance coupling may be good at detecting when an object touches the panel. Furthermore, and also contrary to electrodes that implement self-capacitance coupling, electrodes that implement mutual capacitance coupling may not be good at detecting when an object is only near the panel, but not touching the panel (e.g., detecting proximity). As such, in particular embodiments, electrodes that implement mutual capacitance coupling may primarily be used in a touch screen to detect when an object touches the panel of the touch screen.

FIG. 1D illustrates a system 300 with a two-layer configuration of electrodes that implement mutual capacitance coupling. In particular embodiments, the electrode configuration of system 300 of FIG. 1C may be an example of an electrode configuration of touch sensor 10 of FIG. 1A.

According to the illustrated embodiment, a finger 324 causes field lines 316 normally coupling from drive electrode 304 to sense electrode 308 across substrate 310 to be absorbed by finger 324, as shown at 320. The result of this action is a very detectable change in capacitance of the capacitive node formed by drive electrode 304 and sense electrode 308. In particular embodiments, the change in capacitance is related to a variety of factors such as fingerprint area, electrode area, panel 312 thickness and dielectric constant, human body size and location, skin thickness and conductivity, and other factors. In particular embodiments, the change in capacitance is sensed by receiver 332.

FIG. 1E illustrates an example touch sensor 400 having a two-layer configuration of electrodes that implement mutual capacitance coupling. In particular embodiments, touch sensor 400 of FIG. 1E may be an example of touch sensor 10 of FIG. 1A.

According to the illustrated embodiment, touch sensor 400 includes edges, drive electrodes, and sense electrodes. Edges (which are illustrated in FIG. 1E as edge 404a, edge 404b, edge 404c, and edge 404d) comprise a barrier between the touch-sensitive area of touch sensor 400 and a touch-insensitive area of touch sensor. In particular embodiments, when a user touches (or comes in close proximity to) touch sensor 400 within the edges, the touch (or close proximity) is sensed by touch sensor 400.

Drive electrodes (one of which is illustrated in FIG. 1E as drive electrode 408) and sense electrodes (one of which is illustrated in FIG. 1E as sense electrode 412) are each an area of conductive material forming a shape, such as for example a disc, square, rectangle, other suitable shape, or any suitable combination of these. In the illustrated embodiment, drive electrodes are disposed in a pattern on one side of a substrate and sense electrodes are disposed in a pattern on another side of the substrate. In such a configuration, an intersection of a drive electrode and a sense electrode may form a capacitive node (one of which is illustrated as capacitive node 416). Such an intersection may be a location where the drive electrode and the sense electrode “cross” or come nearest each other in their respective planes. The drive and sense electrodes do not make electrical contact with each other—instead they are capacitively coupled to each other across the substrate at the intersection.

As illustrated, touch sensor 400 includes a example pattern for the drive electrodes and sense electrodes. According to the illustrated embodiment, the drive electrodes (such as drive electrode 408) are parallel to edge 404a and edge 404d. In particular embodiments, the drive electrodes may be approximately parallel to edge 404a and edge 404d. For example, the drive electrodes may be approximately parallel to edge 404a and edge 404d due to one or more deviations in the shape of edge 404a, edge 404d, and/or the drive electrodes. Furthermore, each adjacent drive electrode may be separated from the next drive electrode by a gap (one of which is illustrated in FIG. 1E as drive electrode gap 420). In particular embodiments, each drive electrode gap may have any suitable size. For example, each gap may be 30 micrometers (μm). As another example, each gap may be 300 μm. As a further example each gap may be 30 μm-300 μm. As a further example, each gap may be less than 30 μm or greater than 300 μm.

In the illustrated embodiment, the sense electrodes (such as sense electrode 412) are parallel to edge 404b and edge 404c. In particular embodiments, the sense electrodes may be approximately parallel to edge 404b and edge 404c. For example, the sense electrodes may be approximately parallel to edge 404b and edge 404c due to one or more deviations in the shape of edge 404b, edge 404c, and/or the sense electrodes. Furthermore, each adjacent sense electrode may be separated from the next sense electrode by a gap (one of which is illustrated in FIG. 1E as sense electrode gap 424). In particular embodiments, each sense electrode gap may have any suitable size. For example, each gap may be 3 millimeters (mm). As another example, each gap may be 7 mm. As a further example each gap may be 3 mm-7 mm. As a further example, each gap may be less than 3 mm or greater than 7 mm.

FIG. 1F illustrates another example touch sensor 500 having a two-layer configuration of electrodes that implement mutual capacitance coupling. In particular embodiments, touch sensor 500 of FIG. 1F may be an example of touch sensor 10 of FIG. 1A.

According to the illustrated embodiment, touch sensor 500 includes edges, drives electrodes, and sense electrodes. Drive electrodes (one of which is illustrated in FIG. 1F as drive electrode 508) and sense electrodes (one of which is illustrated in FIG. 1F as sense electrode 520) are each an area of conductive material forming a shape, such as for example a disc, square, rectangle, other suitable shape, or any suitable combination of these. In the illustrated embodiment, drive electrodes are disposed in a pattern on one side of a substrate and sense electrodes are disposed in a pattern on another side of the substrate. In such a configuration, an intersection of a drive electrode and a sense electrode may form a capacitive node (one of which is illustrated as capacitive node 532). Such an intersection may be a location where the drive electrode and the sense electrode “cross” or come nearest each other in their respective planes. The drive and sense electrodes do not make electrical contact with each other—instead they are capacitively coupled to each other across the substrate at the intersection.

According to the illustrated embodiment, each drive electrode includes a spine (one of which is illustrated in FIG. 1F as spine 512) and one or more drive electrode conductive areas (one of which is illustrated in FIG. 1F as drive electrode conductive area 516). In one embodiment, the drive electrode conductive areas may have any suitable shape, such as for example a disc, square, rectangle, diamond, other suitable shape, or any suitable combination of these. In particular embodiments, the drive electrode conductive areas may allow touch sensor 500 to sense a user when a user comes in contact (or comes in close proximity) to an area of touch sensor 500 that is in-between the spines of drive electrodes (such as in-between spine 512 of drive electrode 508 and the spine of the next adjacent drive electrode). In particular, when a user comes in contact (or comes in close proximity) to an area of touch sensor 500 that it is in-between the spines of drive electrodes, a reasonable interpolated signal may be generated based on the user coming in contact (or coming in close proximity) to each of the drive electrode conducted areas of the adjacent drive electrodes (as opposed to the spines themselves).

According to the illustrated embodiment, each sense electrode includes a spine (one of which is illustrated in FIG. 1F as spine 524) and one or more conductive elements (one of which is illustrated in FIG. 1F as conductive element 528). In particular embodiments, the conductive elements may have any suitable shape, such as for example a disc, square, rectangle, diamond, other suitable shape, or any suitable combination of these. In particular embodiments, the conductive elements may include a plurality of conductive structures that extend from either side of each spine in a pattern. In particular embodiments, the pattern may be any suitable pattern. As one example, as is illustrated in FIG. 1F, the pattern of conductive structures of the conductive element may resemble a snowflake. In particular embodiments, the conductive element may allow touch sensor 500 to sense a user when a user comes in contact (or comes in close proximity) to an area of touch sensor 500 that is in-between the spine of sense electrodes (such as in-between spine 524 of sense electrode 520 and the spine of the next adjacent sense electrode). In particular, when a user comes in contact (or comes in close proximity) to an area of touch sensor 500 that is in-between the spines of sense electrodes, a reasonable interpolated signal may be generated based on the user coming in contact (or coming in close proximity) to each of the cross parts of the adjacent sense electrodes (as opposed to the spines themselves).

As illustrated, touch sensor 500 includes an example pattern of the drive electrodes and sense electrodes. According to the illustrated embodiment, the spines of the drive electrodes (such as spine 512 of drive electrode 508) are parallel to edge 504a and edge 504d. In particular embodiments, the spines may be approximately parallel to edge 504a and edge 504d. For example, the spines may be approximately parallel to edge 504a and edge 504d due to one or more deviations in the shape of edge 504a, edge 504d, and/or the spine.

According to the illustrated embodiment, the spines of the sense electrodes (such as spine 524 of sense electrode 520) are parallel to edge 504b and edge 504c. In particular embodiments, the spines may be approximately parallel to edge 504b and edge 504c. For example, the spines may be approximately parallel to edge 504b and edge 504c due to one or more deviations in the shape of edge 504b, edge 504c, and/or the spine.

FIG. 1G illustrates another example touch sensor 600 having a two-layer configuration of electrodes that implement mutual capacitance coupling. In particular embodiments, touch sensor 600 of FIG. 1G may be an example of touch sensor 10 of FIG. 1A.

According to the illustrated embodiment, touch sensor 600 includes edges, drives electrodes, and sense electrodes described in detail in FIG. 1F. The sense electrodes of touch sensor 600 of FIG. 1G, however, include sense electrode conductive areas (one of which is illustrated in FIG. 1G as sense electrode conductive area 528) that each have the shape of a diamond. Furthermore, the drive electrodes of touch sensor 600 of FIG. 1G include drive electrode conductive areas (one of which is illustrated in FIG. 1G as drive electrode conductive area 516) that each have the shape of a diamond. Although the sense electrode conductive areas and the drive electrode conductive areas are illustrated as each having the shape of a diamond, either the sense electrode conductive areas, the drive electrode conductive areas, or both, may have any other shape, such as for example a disc, square, rectangle, other suitable shape, or any suitable combination of these.

In particular embodiments, touch sensor 400 of FIG. 1E, touch sensor 500 of FIG. 1F, and touch sensor 600 of FIG. 1G may be deficient. For example, as is discussed above, the electrodes included in touch sensor 400, touch sensor 500, and touch sensor 600 implement mutual capacitance coupling. Electrodes that implement mutual capacitance coupling may be good at detecting when an object (such as a finger) touches the panel of a touch sensor, but may not be good at detecting when an object (such as a finger) is near the panel, but not touching the panel (e.g., detecting proximity). Furthermore, contrary to electrodes that implement mutual capacitance coupling, electrodes that implement self-capacitance coupling may be good at detecting when an object is near the panel, but not touching it, but may not be good at detecting when an object touches the panel of the touch sensor.

In order to provide a touch screen that is good at detecting when an object touches the panel and is also good at detecting when an object is only near the panel, various electrodes that implement mutual capacitance coupling have typically been used in the touch sensor of the touch screen, while various electrodes that implement self-capacitance coupling have typically been added to the sides of the touch screen (e.g., they are not added to the touch sensor, itself). For example, with regard to touch sensor 400 of FIG. 1E, various electrodes that implement self-capacitance coupling have typically been added to areas outside of the edges of touch sensor 400 (such as outside the area created by edge 404a, edge 404b, edge 404c, and edge 404d). As another example, with regard to touch sensor 500 of FIG. 1F and touch sensor 600 of FIG. 1G, various electrodes that implement self-capacitance coupling have typically been added to areas outside of the edges of touch sensor 500 and touch sensor 600 (such as outside the area created by edge 504a, edge 504b, edge 504c, and edge 504d). As such, these electrodes that implement self-capacitance coupling have typically been added in a touch-insensitive area of the touch screen so as to provide better proximity detection. In particular embodiments, the electrodes that implement self-capacitance coupling have typically been located outside of the edges of a touch sensor (as opposed to inside the edges of the touch sensor) because such a configuration may avoid interference. For example, the pulses of the electric field emitted by the electrodes that implement self-capacitance coupling may interfere with the pulses of the electric field emitted by electrodes that implement mutual capacitance coupling. As such, by adding the electrodes that implement self-capacitance coupling to an area outside of the edges of a touch sensor, the electrodes that implement self-capacitance coupling have typically not interfered with the electrodes the implement mutual capacitance coupling.

In particular embodiments, although adding various electrodes that implement self-capacitance coupling to an area outside of the edges of a touch sensor may allow a touch screen to provide better proximity detection, the proximity detection of the touch screen may only be increased outside of the edges of the touch sensor. That is, such typical solutions may not increase the ability of the touch screen to detect the proximity of an object inside of the edges of the touch sensor (such as inside the area created by edge 404a, edge 404b, edge 404c, and edge 404d of FIG. 1E, or inside the area created by edge 504a, edge 504b, edge 504c, and edge 504d of FIGS. 1F and 1G). As such, the typical solutions for providing a better touch screen are deficient.

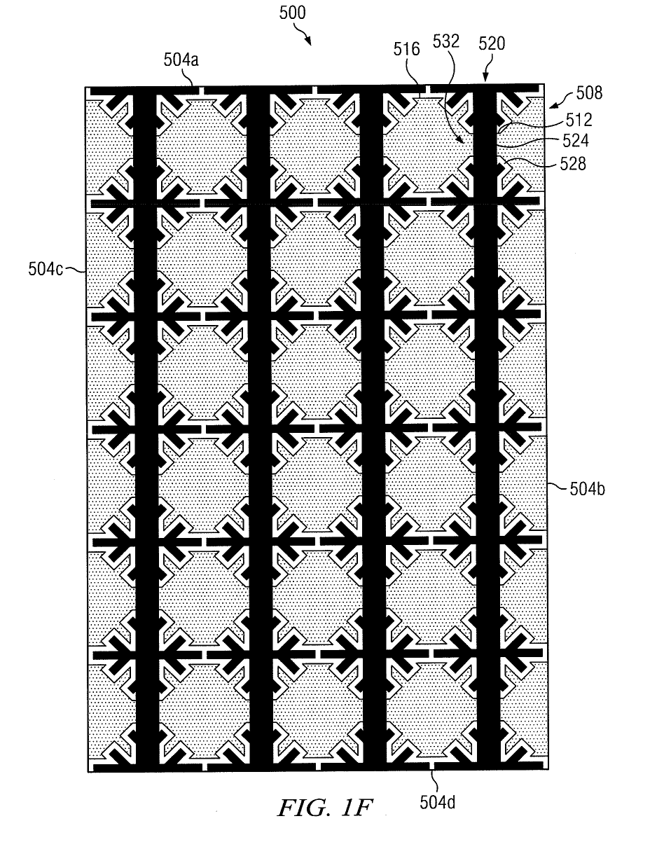

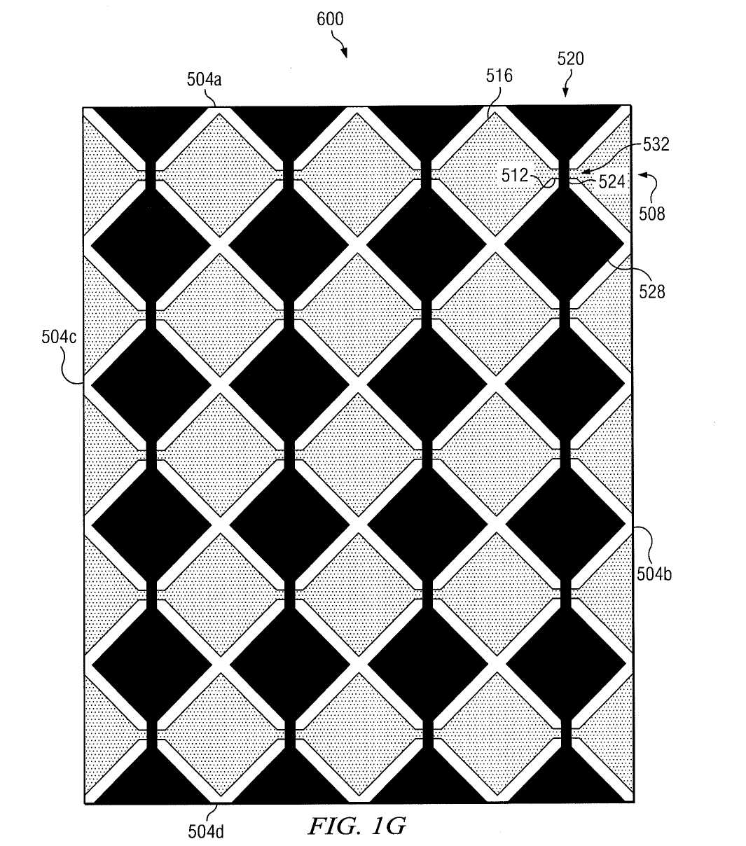

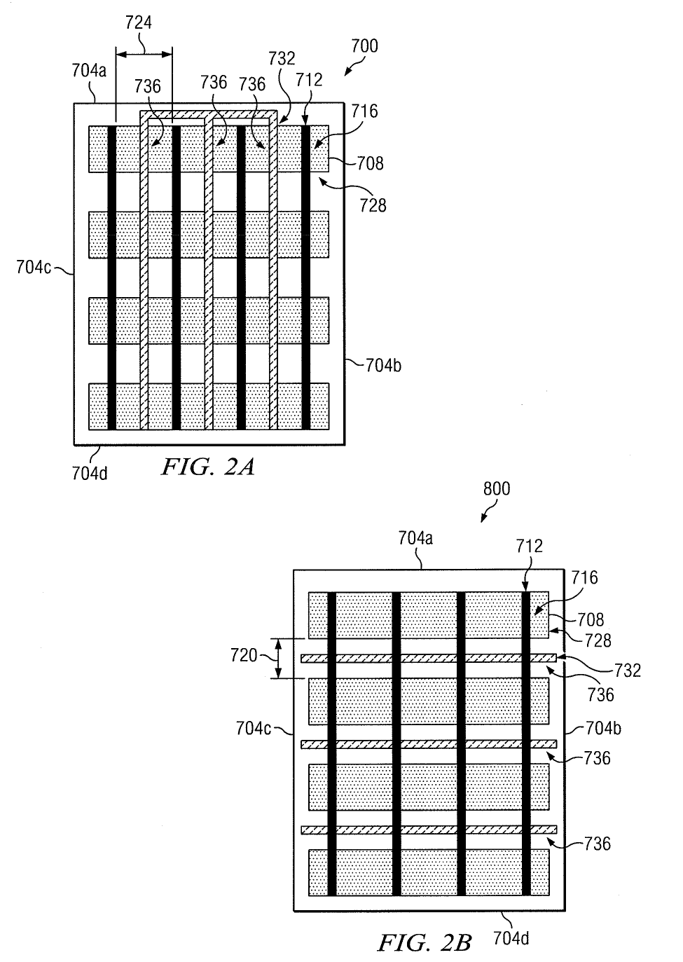

In particular embodiments, the deficiencies of touch sensor 400 of FIG. 1E, touch sensor 500 of FIG. 1F, touch sensor 600 of FIG. 1G, and any other touch sensor that includes electrodes that implement mutual capacitance coupling (such as touch sensors that include electrode patterns with interdigitized drive electrodes, interdigitized sense electrodes, a single layer configuration, and/or a two-layer configuration), may be reduced by a touch sensor that includes both electrodes that implement mutual capacitance coupling and electrodes that implement self-capacitance coupling. In particular embodiments, by positioning both electrodes that implement mutual capacitance coupling and electrodes that implement self-capacitance coupling inside of the edges of a touch sensor, the touch sensor (and the touch screen) may be able to provide good detection of both an object that touches the panel of the touch sensor and an object that only comes near the panel of the touch sensor (as opposed to actually touching it). FIGS. 2A, 2B, 3, and 4 illustrate examples of touch sensors that include both electrodes that implement mutual capacitance coupling and electrodes that implement self-capacitance coupling, according to particular embodiments.

FIG. 2A illustrates an example touch sensor 700 that includes both electrodes that implement mutual capacitance coupling and electrodes that implement self-capacitance coupling. In particular embodiments, touch sensor 700 may be similar to touch sensor 400 of FIG. 1E, except that touch sensor 700 includes both electrodes that implement mutual capacitance coupling and electrodes that implement self-capacitance coupling.

According to the illustrated embodiment, touch sensor 700 includes electrodes that implement mutual capacitance coupling (one example of which is illustrated in FIG. 2A as mutual capacitance coupling electrodes 728) and electrodes that implement self-capacitance coupling (one example of which is illustrated in FIG. 2A as self-capacitance coupling electrode 732). In the illustrated embodiment, mutual capacitance coupling electrodes may include drive electrodes (one of which is illustrated in FIG. 2A as drive electrode 708) and sense electrodes (one of which is illustrated in FIG. 2A as sense electrode 712) that may intersect with each other in order to form capacitive nodes (one of which is illustrated as mutual capacitive node 716). Such an intersection may be a location where the drive electrode and the sense electrode “cross” or come nearest each other in their respective planes. The drive and sense electrodes do not make electrical contact with each other—instead they are capacitively coupled to each other across the substrate at the intersection.

Additionally, the self-capacitance coupling electrodes (one of which is illustrated in FIG. 1G as self-capacitance coupling electrode 732) may form a single capacitive node (which is illustrated in FIG. 2A as self-capacitive node 736). In particular embodiments, even though there are multiple self-capacitance coupling electrodes, only one self-capacitive node is formed. In particular embodiments, this one self-capacitive node may generally have the same shape and positioning as each of the self-capacitance coupling electrodes. As such, if an object comes near the location of any of the self-capacitance coupling electrodes, the self-capacitive node may detect the object. In particular embodiments, each self-capacitance coupling electrode may form a portion of the self-capacitance node. For example, self-capacitance coupling electrode 732 may form the portion of the self-capacitance node that corresponds with the location of self-capacitance coupling electrode 732.

In particular embodiments, the self-capacitance coupling electrodes may be positioned in any manner in touch sensor 700. For example, according to the illustrated embodiment, the self-capacitance coupling electrodes (such as self-capacitance coupling electrode 732) may be positioned in a gap in-between adjacent sense electrodes of the mutual capacitance coupling electrodes (such as in sense electrode gap 724). In particular embodiments, each self-capacitance coupling electrode may be positioned anywhere in the sense electrode gaps of touch sensor 700. For example, each self-capacitance coupling electrode may be positioned in a sense electrode gap so as to be half-way in-between each adjacent sense electrode. As another example, each self-capacitance coupling electrode may be positioned 0.1 mm-0.4 mm from each sense electrode of the mutual capacitance coupling electrodes.

In particular embodiments, by positioning each self-capacitance coupling electrode in the sense electrode gaps (e.g., in-between adjacent sense electrodes of mutual capacitance coupling electrodes), at least a portion of the self-capacitive node may be located in-between two adjacent mutual capacitive nodes. For example, as is discussed above, the mutual capacitance electrodes may form a plurality of mutual capacitive nodes (one of which is illustrated as mutual capacitive node 716). Furthermore, the self-capacitance electrodes may also form a single self-capacitive node (which is illustrated as self-capacitive node 736). In particular embodiments, when the self-capacitance coupling electrodes are positioned in the sense electrode gaps (e.g., in-between adjacent sense electrodes of mutual capacitance coupling electrodes) at least a portion of the self-capacitive node may be located in-between at least two adjacent mutual capacitive nodes. For example, as is illustrated in FIG. 2A, a portion of self-capacitive node 736 (such as the portion formed by self-capacitance electrode 732) may be positioned in-between mutual capacitive node 716 (formed by mutual capacitance coupling electrode 728) and the next adjacent mutual capacitive node (which is formed by the mutual capacitance coupling electrode that is adjacent to mutual capacitance coupling electrode 728).

In particular embodiments, in order to form capacitive nodes, both mutual capacitance coupling electrodes and self-capacitance coupling electrodes each emit pulses of an electric field (as is discussed in detail in FIGS. 1B-1D). In particular embodiments, the self-capacitance coupling electrodes may be positioned in touch sensor 700 so as to not interfere with the pulsing of an electric field from the mutual capacitance coupling electrodes. In particular embodiments, a self-capacitance coupling electrode may not interfere with the pulses of an electric field from the mutual capacitance coupling electrodes (which include both a drive electrode and a receive electrode) when the self-capacitance coupling electrode is positioned 0.1 mm-0.4 mm from each sense electrode of the mutual capacitance coupling electrodes.

In particular embodiments, the pulses of electric fields emitted by self-capacitance coupling electrodes and mutual capacitance coupling electrodes may be synchronized so as to prevent interference. For example, in particular embodiments, the pulses of the electric field emitted by mutual capacitance coupling electrodes may be alternatingly synchronized with pulses of the electric field emitted by self-capacitance coupling electrodes, so that at any one time, pulses are emitted from only the mutual capacitance coupling electrodes or the self-capacitance electrodes, not both. As such, the pulses of an electric field emitted by the self-capacitance coupling electrodes may not interfere with the pulses of electric fields emitted by the mutual capacitance coupling electrodes.

According to the illustrated embodiment, because touch sensor 700 includes both electrodes that implement mutual capacitance coupling and electrodes that implement self-capacitance coupling, a touch screen that utilizes touch sensor 700 may provide good detection of both an object that touches the panel of the touch sensor and an object that only comes near the panel of the touch sensor (as opposed to actually touching it). Furthermore, since the electrodes that implement self-capacitance coupling are located inside the edges of the touch sensor (e.g., inside the area created by edge 704a, edge 704b, edge 704c, and edge 704d), better proximity detection may be provided inside the edges of the touch sensor. As such, the touch screen may provide more accurate proximity detection.

FIG. 2B illustrates a touch sensor 800 that includes both electrodes that implement mutual capacitance coupling and electrodes that implement self-capacitance coupling. In particular embodiments, touch sensor 800 may be similar to touch sensor 400 of FIG. 1E, except that touch sensor 800 includes both electrodes that implement mutual capacitance coupling and electrodes that implement self-capacitance coupling.

According to the illustrated embodiment, touch sensor 800 includes electrodes that implement mutual capacitance coupling (one example of which is illustrated in FIG. 2B as mutual capacitance coupling electrodes 728) and electrodes that implement self-capacitance coupling (one example of which is illustrated in FIG. 2B as self-capacitance coupling electrode 732).

Contrary to FIG. 2A, according to the embodiment illustrated in FIG. 2B, the self-capacitance coupling electrodes (such as self-capacitance coupling electrode 732) may be positioned in-between adjacent drive electrodes of the mutual capacitance coupling electrodes (such as in drive electrode gap 720). In particular embodiments, in order to position the self-capacitance coupling electrodes in the drive electrode gaps, the size of the gaps may be increased. For example, the size of the gaps may be increased from 30 μm-300 μm to 1 mm-2 mm. In particular embodiments, each self-capacitance coupling electrode may be positioned anywhere in the drive electrode gaps of touch sensor 800. For example, each self-capacitance coupling electrode may be positioned in the drive electrode gap so as to be half-way in-between each adjacent drive electrode. As another example, each self-capacitance coupling electrode may be positioned 0.03 mm-0.4 mm from each drive electrode of the mutual capacitance coupling electrodes.

In particular embodiments, by positioning each self-capacitance coupling electrode in the drive electrode gaps (e.g., in-between adjacent drive electrodes of mutual capacitance coupling electrodes), at least a portion of the self-capacitive node may be located in-between two adjacent mutual capacitive nodes. For example, as is discussed above, the mutual capacitance electrodes may form a plurality of mutual capacitive nodes (one of which is illustrated as mutual capacitive node 716). Furthermore, the self-capacitance electrodes may also form a single self-capacitive node (which is illustrated as self-capacitive node 736). In particular embodiments, when the self-capacitance coupling electrodes are positioned in the drive electrode gaps (e.g., in-between adjacent drive electrodes of mutual capacitance coupling electrodes) at least a portion of the self-capacitive node may be positioned in-between at least two adjacent mutual capacitive nodes. For example, as is illustrated in FIG. 2B, a portion of self-capacitive node 736 (such as the portion formed by self-capacitance electrode 732) may be positioned in-between mutual capacitive node 716 (formed by mutual capacitance coupling electrode 728) and the next adjacent mutual capacitive node (which is formed by the mutual capacitance coupling electrode that is adjacent to mutual capacitance coupling electrode 728).

In particular embodiments, in order to form capacitive nodes, both mutual capacitance coupling electrodes and self-capacitance coupling electrodes each emit pulses of an electric field (as is discussed in detail in FIGS. 1B-1D). In particular embodiments, the self-capacitance coupling electrodes may be positioned in touch sensor 800 so as to not interfere with the pulsing of an electric field from the mutual capacitance coupling electrodes. In particular embodiments, a self-capacitance coupling electrode may not interfere with the pulses of an electric field from the mutual capacitance coupling electrodes (which include both a drive electrode and a receive electrode) when the self-capacitance coupling electrode is positioned 0.03 mm-0.4 mm from each drive electrode of the mutual capacitance coupling electrodes.

In particular embodiments, the pulses of electric fields emitted by self-capacitance coupling electrodes and mutual capacitance coupling electrodes may be synchronized so as to prevent interference. For example, in particular embodiments, the pulses of the electric field emitted by mutual capacitance coupling electrodes may be alternatingly synchronized with pulses of the electric field emitted by self-capacitance coupling electrodes, so that at any one time, pulses are emitted from only the mutual capacitance coupling electrodes or the self-capacitance electrodes, not both. As such, the pulses of an electric field emitted by the self-capacitance coupling electrodes may not interfere with the pulses of electric fields emitted by the mutual capacitance coupling electrodes.

According to the illustrated embodiment, because touch sensor 800 includes both electrodes that implement mutual capacitance coupling and electrodes that implement self-capacitance coupling, a touch screen that utilizes touch sensor 800 may provide good detection of both an object that touches the panel of the touch sensor and an object that only comes near the panel of the touch sensor (as opposed to actually touching it). Furthermore, since the electrodes that implement self-capacitance coupling are located inside the edges of the touch sensor (e.g., inside the area created by edge 704a, edge 704b, edge 704c, and edge 704d), better proximity detection may be provided inside the edges of the touch sensor. As such, the touch screen may provide more accurate proximity detection.

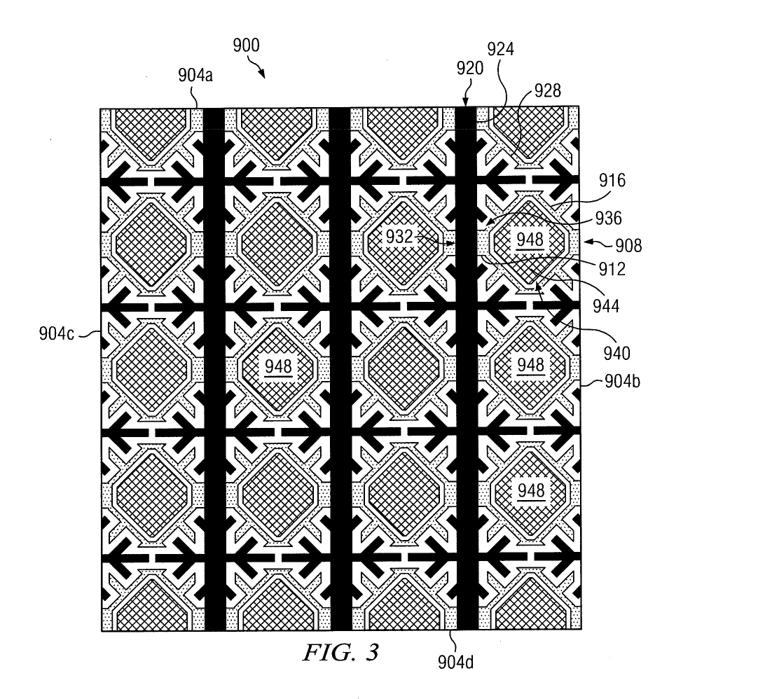

FIG. 3 illustrates a touch sensor 900 that includes both electrodes that implement mutual capacitance coupling and electrodes that implement self-capacitance coupling. In particular embodiments, touch sensor 900 may be similar to touch sensor 500 of FIG. 1F, except that touch sensor 900 includes both electrodes that implement mutual capacitance coupling and electrodes that implement self-capacitance coupling.

According to the illustrated embodiment, touch sensor 900 includes electrodes that implement mutual capacitance coupling (one example of which is illustrated in FIG. 3 as mutual capacitance coupling electrodes 936) and electrodes that implement self-capacitance coupling (one example of which is illustrated in FIG. 3 as self-capacitance coupling electrode 944).

In the illustrated embodiment, mutual capacitance coupling electrodes may include drive electrodes (one of which is illustrated in FIG. 3 as drive electrode 908) and sense electrodes (one of which is illustrated in FIG. 3 as sense electrode 920) that may intersect with each other in order to form capacitive nodes (one of which is illustrated as mutual capacitive node 932). Such an intersection may be a location where the drive electrode and the sense electrode “cross” or come nearest each other in their respective planes. The drive and sense electrodes do not make electrical contact with each other—instead they are capacitively coupled to each other across the substrate at the intersection.

Additionally, the self-capacitance coupling electrodes may form a single capacitive node (which is illustrated in FIG. 3 as self-capacitive node 948). In particular embodiments, even though there are multiple self-capacitance coupling electrodes, only one self-capacitive node is formed. In particular embodiments, this one self-capacitive node may generally have the same shape and positioning as each of the self-capacitance coupling electrodes. As such, if an object comes near the location of any of the self-capacitance coupling electrodes, the self-capacitive node may detect the object. In particular embodiments, each self-capacitance coupling electrode may form a portion of the self-capacitance node. For example, self-capacitance coupling electrode 944 may form the portion of the self-capacitance node that corresponds with the location of self-capacitance coupling electrode 944.

In particular embodiments, the self-capacitance coupling electrodes may be positioned in any manner in touch sensor 900. For example, according to the illustrated embodiment, the self-capacitance coupling electrodes (such as self-capacitance coupling electrodes 944) may be positioned in the drive electrodes. In particular, the drive electrodes (one of which is illustrated as drive electrode 908) may include one or more hollowed out portions (one of which is illustrated in FIG. 3 as hollowed out portion 940). In particular embodiments, the hollowed out portions of the drive electrodes may refer to any portion of the drive electrode where the conductive material of the drive electrode has been removed. In particular embodiments, the conductive material of the drive electrode may be removed in any suitable manner. In particular embodiments, the hollowed out portion of the drive electrode may have any suitable size and shape. For example, the hollowed out portion of the drive electrode may be shaped as, for example, a disc, square, rectangle, diamond, other suitable shape, or any suitable combination of these. In particular embodiments, the self-capacitance coupling electrodes (one of which is illustrated as self-capacitance coupling electrode 944) may be positioned in the hollowed out portions of the drive electrodes (such as positioned within hollowed out portion 940).

In particular embodiments, the hollowed out portions of the drive electrodes may be positioned at any location in the drive electrodes. For example, the hollowed out portion may be positioned in the spine of the drive electrodes (such as in spine 912). As another example, the hollowed out portions may be positioned in the conductive areas of the drive electrodes (such as in conductive area 916). Furthermore, although FIG. 3 illustrates a hollowed out portion (and a self-capacitance coupling electrode inside the hollowed out portion) in each conductive area of each drive electrode, in particular embodiments, the hollowed out portions of the drive electrodes (and the self-capacitance coupling electrode) may not be in all of the conductive areas of the drive electrodes. For example, the hollowed out portions of the drive electrodes (and the self-capacitance coupling electrode) may only be in some (such as one or more) of the conductive areas of the drive electrodes.

In particular embodiments, the pulses of electric fields emitted by self-capacitance coupling electrodes and the mutual capacitance coupling electrodes may be synchronized so as to prevent interference. For example, in particular embodiments, the pulses of the electric field emitted by the mutual capacitance coupling electrodes may be alternatingly synchronized with pulses of the electric field emitted by the self-capacitance coupling electrodes, so that at any one time, pulses are emitted from only the mutual capacitance coupling electrodes or the self-capacitance electrodes, not both. As such, the pulses of an electric field emitted by the self-capacitance coupling electrodes may not interfere with the pulses of electric fields emitted by the mutual capacitance coupling electrodes.

According to the illustrated embodiment, because touch sensor 900 includes both electrodes that implement mutual capacitance coupling and electrodes that implement self-capacitance coupling, a touch screen that utilizes touch sensor 900 may provide good detection of both an object that touches the panel of the touch sensor and an object that only comes near the panel of the touch sensor (as opposed to actually touching it). Furthermore, since the electrodes that implement self-capacitance coupling are located inside the edges of the touch sensor (e.g., inside the area created by edge 904a, edge 904b, edge 904c, and edge 904d), better proximity detection may be provided inside the edges of the touch sensor. As such, the touch screen may provide more accurate proximity detection.

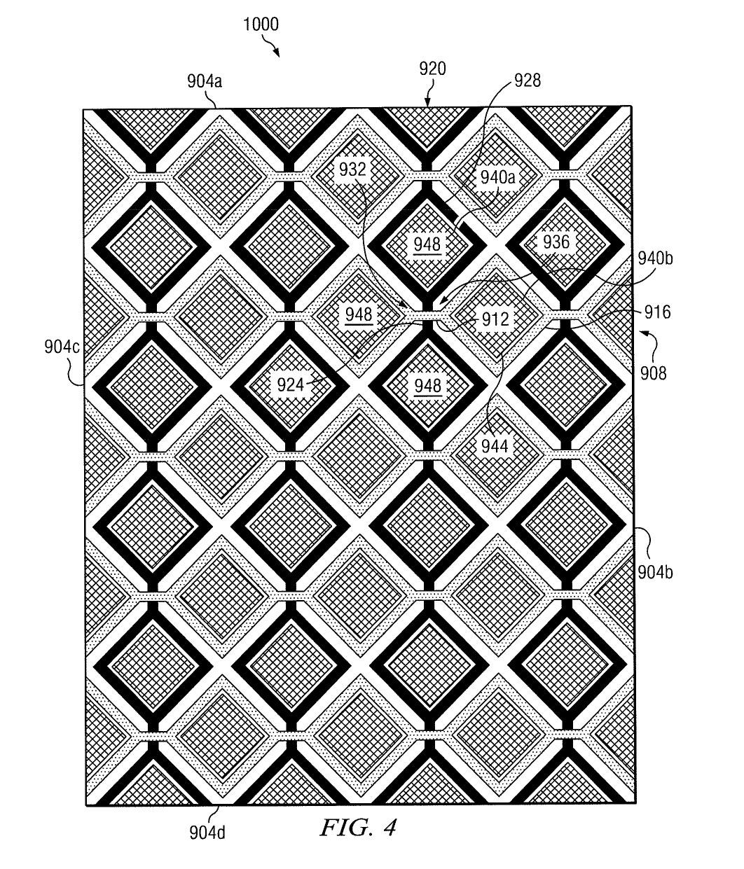

FIG. 4 illustrates a touch sensor 1000 that includes both electrodes that implement mutual capacitance coupling and electrodes that implement self-capacitance coupling. In particular embodiments, touch sensor 1000 may be similar to touch sensor 600 of FIG. 1G, except that touch sensor 1000 includes both electrodes that implement mutual capacitance coupling and electrodes that implement self-capacitance coupling. In particular embodiments, the electrodes that implement mutual capacitance coupling (one example of which is illustrated in FIG. 4 as mutual capacitance coupling electrode 936) and the electrodes that implement self-capacitance coupling (one example of which is illustrated in FIG. 4 as self-capacitance coupling electrode 944) may be similar to those described in FIG. 3.

However, unlike FIG. 3, in FIG. 4, the self-capacitance coupling electrodes may be positioned in both the drive electrodes and the sense electrodes. In particular, the drive electrodes (one of which is illustrated as drive electrode 908) and the sense electrodes (one of which is illustrated as sense electrode 912) may include one or more hollowed out portions (examples of which are illustrated in FIG. 4 as hollowed out portions 940a and 940b). In particular embodiments, the hollowed out portions of the drive electrodes and sense electrodes may refer to any portion of the drive electrode and sense electrode where the conductive material of the drive electrode or sense electrode has been removed. In particular embodiments, the conductive material of the drive electrode or sense electrode may be removed in any suitable manner. In particular embodiments, the hollowed out portion of the drive electrode or sense electrode may have any suitable size and shape. For example, the hollowed out portion of the drive electrode or sense electrode may be shaped as, for example, a disc, square, rectangle, diamond, other suitable shape, or any suitable combination of these. In particular embodiments, the self-capacitance coupling electrodes (examples of which are illustrated as self-capacitance coupling electrodes 944a and 944b) may be positioned in the hollowed out portions of the drive electrodes and the sense electrodes (such as positioned within hollowed out portions 940a and 940b).

In particular embodiments, the hollowed out portions of the drive electrodes and sense electrodes may be positioned at any location in the drive electrodes and sense electrodes. For example, the hollowed out portions may be positioned in the spine of the drive electrodes (such as in spine 912) and the spine of the sense electrode (such as spine 924). As another example, the hollowed out portions may be positioned in the conductive areas of the drive electrodes (such as in conductive area 916) and the conductive areas of the sense electrodes (such as in conductive area 928). Furthermore, although FIG. 4 illustrates a hollowed out portion (and a self-capacitance coupling electrode inside the hollowed out portion) in each conductive area of each drive electrode and each sense electrode, in particular embodiments, the hollowed out portions of the drive electrodes and the sense electrodes (and the self-capacitance coupling electrodes) may not be in all of the conductive areas of the drive electrodes and/or sense electrodes. For example, the hollowed out portions of the drive electrodes and the sense electrodes (and the self-capacitance coupling electrodes) may only be in some (such as one or more) of the conductive areas of the drive electrodes and/or sense electrodes. Furthermore, in particular embodiments, the hollowed out portions (and the self-capacitance electrodes) may only be in the drive electrodes or the sense electrodes (as opposed to being in both the drive and sense electrodes).

According to the illustrated embodiment, because touch sensor 1000 includes both electrodes that implement mutual capacitance coupling and electrodes that implement self-capacitance coupling, a touch screen that utilizes touch sensor 1000 may provide good detection of both an object that touches the panel of the touch sensor and an object that only comes near the panel of the touch sensor (as opposed to actually touching it). Furthermore, since the electrodes that implement self-capacitance coupling are located inside the edges of the touch sensor (e.g., inside the area created by edge 904a, edge 904b, edge 904c, and edge 904d), better proximity detection may be provided inside the edges of the touch sensor. As such, the touch screen may provide more accurate proximity detection.

Modifications, additions, or omissions may be made to the touch sensors of FIGS. 2A-4 without departing from the scope of the disclosure. For example, although each of FIGS. 2A-4 illustrates a particular embodiment for providing good detection of both an object that touches the panel of the touch sensor and an object that only comes near the panel of the touch sensor, in particular embodiments, two or more of the particular embodiments illustrated in FIGS. 2A-4 may be combined. In particular, with regard to FIGS. 2A and 2B, electrodes that implement self-capacitance coupling may be located in the gaps in-between adjacent sense electrodes of the mutual capacitance coupling electrodes and the gaps in-between adjacent drive electrodes of the mutual capacitance coupling electrodes. As another example, although FIGS. 2A-4 illustrate example touch sensors having particular electrode patterns, touch sensors may include any electrode pattern that includes both electrodes that implement mutual capacitance coupling and electrodes the implement self-capacitance coupling. In particular, both electrodes that implement mutual capacitance coupling and electrodes the implement self-capacitance coupling may be included in any other touch sensor electrode patterns, such as any electrode pattern having a single-layer configuration or a two-layer configuration.

FIG. 5 illustrates a device 1100 that may incorporate any of the touch sensors of FIGS. 1A-4. Device 1100 may include a desktop computer, laptop computer, tablet computer, PDA, Smartphone, satellite navigation device, telephone, cell phone, portable media player, portable game console, kiosk computer, point-of-sale device, household appliance, automatic teller machine (ATM), any other device, or any combination of the preceding.

According to the illustrated embodiment, device 1100 includes a touch screen display 1104. Touch screen display 1104 enables the touch screen to present a wide variety of data, including a keyboard, a numeric keypad, program or application icons, and various other interfaces as desired. The user may interact with device 1100 by touching touch screen display 1104 with a single finger (or any other object), such as to select a program for execution or to type a letter on a keyboard displayed on the touch screen display 1104. In addition, the user may use multiple touches, such as to zoom in or zoom out when viewing a document or image. In particular embodiments of device 1100, such as home appliances, touch screen display 1104 may not change or may change only slightly during device operation, and may recognize only single touches.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A touch sensor having a first edge and a second edge approximately perpendicular to the first edge, the touch sensor comprising:
a first plurality of electrodes approximately parallel to the first edge;
a second plurality of electrodes approximately parallel to the second edge;
a first plurality of nodes, each of the first plurality of nodes formed by a capacitive coupling between an electrode of the first plurality of electrodes and an electrode of the second plurality of electrodes;
a third plurality of electrodes;
a second node formed by the third plurality of electrodes, each of the third plurality of electrodes forming a portion of the second node by a self-capacitance coupling; and
wherein at least one of the portions of the second node is positioned in-between at least two of the first plurality of nodes.

2. The touch sensor of claim 1, wherein:
the second plurality of electrodes are each separated from each other by a gap; and
the third plurality of electrodes are positioned in the plurality of gaps.

3. The touch sensor of claim 1, wherein:
the first plurality of electrodes are each separated from each other by a gap; and
the third plurality of electrodes are positioned in the plurality of gaps.

4. The touch sensor of claim 1, wherein:
each of the first plurality of electrodes is operable to pulse a first electric field towards one or more of the second plurality of electrodes;
each of the third plurality of electrodes is operable to pulse a second electric field through a cover panel positioned over the touch sensor; and
the pulses of the first electric fields are alternatingly synchronized with the pulses of the second electric fields to prevent interference.

5. The touch sensor of claim 1, wherein each of the third plurality of electrodes is positioned so as not to interfere with one or more pulses of an electric field from each of the first plurality of electrodes.

6. A touch sensor having a first edge and a second edge approximately perpendicular to the first edge, the touch sensor comprising:
a first plurality of electrodes, wherein at least one of the first plurality of electrodes comprises a hollowed out portion;
a second plurality of electrodes;
a first plurality of nodes, each of the first plurality of nodes formed by a capacitive coupling between an electrode of the first plurality of electrodes and an electrode of the second plurality of electrodes;
a third plurality of electrodes, wherein at least one of the third plurality of electrodes is positioned in the hollowed out portion of the at least one of the first plurality of electrodes; and
a second node formed by the third plurality of electrodes, each of the third plurality of electrodes forming a portion of the second node by a self-capacitance coupling.

7. The touch sensor of claim 6, wherein:
each of the first plurality of electrodes comprises a portion that is hollowed out; and
the plurality of third electrodes are positioned in the plurality of hollowed out portions.

8. The touch sensor of claim 6, wherein:
at least one of the second plurality of electrodes comprises a hollowed out portion; and
at least a second electrode of the third plurality of electrodes is positioned in the hollowed out portion of the at least one of the second plurality of electrodes.

9. The touch sensor of claim 6, further comprising a substrate comprising a top side and a bottom side, wherein the first plurality of electrodes are positioned on the bottom side of the substrate, wherein the second plurality of electrodes are positioned on the top side of the substrate.

10. The touch sensor of claim 6, wherein each of the second plurality of electrodes comprises a plurality of conductive elements arranged in a snowflake design.

11. A device, comprising:
a controller; and
a touch sensor having a first edge and a second edge approximately perpendicular to the first edge, the touch sensor coupled to the controller, the touch sensor comprising:
a first plurality of electrodes approximately parallel to the first edge;
a second plurality of electrodes approximately parallel to the second edge;
a first plurality of nodes, each of the first plurality of nodes formed by a capacitive coupling between an electrode of the first plurality of electrodes and an electrode of the second plurality of electrodes;
a third plurality of electrodes;
a second node formed by the third plurality of electrodes, each of the third plurality of electrodes forming a portion of the second node by a self-capacitance coupling; and
wherein at least one of the portions of the second node is positioned in-between at least two of the first plurality of nodes.

12. The device of claim 11, wherein:
the second plurality of electrodes are each separated from each other by a gap; and
the third plurality of electrodes are positioned in the plurality of gaps.

13. The device of claim 11, wherein:
the first plurality of electrodes are each separated from each other by a gap; and
the third plurality of electrodes are positioned in the plurality of gaps.

14. The device of claim 11, wherein:
each of the first plurality of electrodes is operable to pulse a first electric field towards one or more of the second plurality of electrodes;
each of the third plurality of electrodes is operable to pulse a second electric field through a cover panel positioned over the touch sensor; and
the pulses of the first electric fields are alternatingly synchronized with the pulses of the second electric fields to prevent interference.

15. The device of claim 11, wherein each of the third plurality of electrodes is positioned so as not to interfere with one or more pulses of an electric field from each of the first plurality of electrodes.

16. A device, comprising:
a controller; and
a touch sensor having a first edge and a second edge approximately perpendicular to the first edge, the touch sensor coupled to the controller, the touch sensor comprising:
a first plurality of electrodes, wherein at least one of the first plurality of electrodes comprises a hollowed out portion;
a second plurality of electrodes;
a first plurality of nodes, each of the first plurality of nodes formed by a capacitive coupling between an electrode of the first plurality of electrodes and an electrode of the second plurality of electrodes;
a third plurality of electrodes, wherein at least one of the third plurality of electrodes is positioned in the hollowed out portion of the at least one of the first plurality of electrodes; and
a second node formed by the third plurality of electrodes, each of the third plurality of electrodes forming a portion of the second node by a self-capacitance coupling.

17. The device of claim 16, wherein:
each of the first plurality of electrodes comprises a portion that is hollowed out; and
the plurality of third electrodes are positioned in the plurality of hollowed out portions.

18. The device of claim 16, wherein:
at least one of the second plurality of electrodes comprises a hollowed out portion; and
at least a second electrode of the third plurality of electrodes is positioned in the hollowed out portion of the at least one of the second plurality of electrodes.

19. The device of claim 16, further comprising a substrate comprising a top side and a bottom side, wherein the first plurality of electrodes are positioned on the bottom side of the substrate, wherein the second plurality of electrodes are positioned on the top side of the substrate.

20. The device of claim 16, wherein each of the second plurality of electrodes comprises a plurality of conductive elements arranged in a snowflake design.
